(19) United States
(12) Patent Application Publication
(10) Pub. No.: US 2025/0244149 A1
(43) Pub. Date: Jul. 31, 2025

(54) Measured Value Acquisition Device for an Inductive Sensor Arrangement

(71) Applicant: Robert Bosch GmbH, Stuttgart (DE)

(72) Inventors: Stefan Kuntz, Flein (DE); Daniel Gerber, Recklinghausen (DE)

(21) Appl. No.: 19/035,246

(22) Filed: Jan. 23, 2025

(30) Foreign Application Priority Data
Jan. 31, 2024 (DE) 10 2024 200 845.1

(51) Int. Cl. G01D 5/20

(52) U.S. Cl. CPC G01D 5/20

(57) ABSTRACT

A measured value acquisition device for an inductive sensor arrangement has a circuit carrier which includes a receiving structure which has at least one receiving coil that includes at least two windings, each including two loop structures with a plurality of loop sections and formed in at least two planes of the circuit carrier. Sections of the individual loop structures arranged in different planes are electrically connected to each other via through-hole platings. The loop sections of the two loop structures have opposite flow directions. The loop structures of the at least two electrically series-connected windings are arranged offset with respect to one another by a predetermined distance. Ends of the individual loop structures of the at least two windings are connected to each other at end regions of the corresponding receiving structure via at least one connecting structure such that an electrical series connection of at least two windings and/or a reversal of a flow direction within one of the at least two windings is created.

This application claims priority under 35 U.S.C. § 119 to application no. DE 10 2024 200 845.1, filed on Jan. 31, 2024 in Germany, the disclosure of which is incorporated herein by reference in its entirety.

The disclosure relates to a measured value acquisition device for an inductive sensor arrangement. The object of the present disclosure is also an inductive sensor arrangement having at least one such measured value acquisition device.

### BACKGROUND

Inductive sensor arrangements are known from the prior art, which have a measured value acquisition device with at least one exciter structure and at least one receiver structure and at least one coupling device, which is also referred to as a target. The at least one exciter structure further comprises at least one exciter coil. The at least one coupling device comprises at least one electrically conductive coupling element. The at least one receiving structure comprises at least one, but usually two, receiving coils. A high frequency current passes through the at least one exciter coil generating an alternating magnetic field, which induces eddy currents in the at least one coupling device. In this context, the inductive coupling of the at least one exciter coil and the at least one receiving coil depends on the position of the corresponding coupling device. The induced voltage signal in the at least one receiver coil can be used to infer the current position of the coupling device and thus the current position of a body whose movement is to be detected.

An inductive angle sensor is known from DE 10 2020 206 396 A1, which comprises an inductive target arrangement with k-fold symmetry as well as a first pickup coil arrangement with k-fold symmetry and a second pickup coil arrangement with k-fold symmetry. A combination device is designed to combine signals of the first pickup coil arrangement with signals of the second pickup coil arrangement and determine an angular error compensated rotation angle based thereon. The pickup individual coils of the first and second pickup coil assemblies are each rotationally offset about the axis of rotation by a geometric offset angle relative to each other. Additionally, the entire first pickup coil arrangement is rotationally offset by a geometric offset angle relative to the entire second pickup coil arrangement about the axis of rotation. In one possible embodiment, the first and second pickup coil arrangements are galvanically coupled to each other and form one or more single pickup coil pairs, wherein, in each pick-p single coil pair, one of the pickup single coils of the first pickup coil arrangement is connected together in a series connection or parallel connection with one pickup single coil of the second pickup coil arrangement, which is offset by the geometric offset angle. The combining device is designed to determine the angular error compensated rotation angle between the stator and the rotor based on a combination of the signals of the respective interconnected pickup single coils of the one or more pickup single coil pairs.

### SUMMARY

The measured value acquisition device for an inductive sensor arrangement with the features set forth below has the advantage that space can be saved and the amplitude of the induced voltage can be increased and the angular error of the measured value acquisition device can be reduced at the same time by efficiently placing connecting structures between several windings of a receiving coil within a corresponding receiving structure. Such premature termination of a loop structure of the receiver coil can enable a series connection of at least two windings of the receiver coil and/or a reversal of the flow direction of a winding. In addition, the series connection within the receiving structure can induce a higher useful voltage in the receiving coil than with a series connection outside the receiving structure. A higher induced voltage results in a better signal-to-noise ratio and increased EMC robustness (EMC: electromagnetic compatibility). Furthermore, this enables the use of more cost-effective semiconductor amplifiers with lower amplification factors. The term “within the receiving structure” is understood here to mean that the connecting structures are arranged within the area spanned by the receiving structure. For example, if the receiving structure extends in a first direction y from y_min to y_max and in a second direction x from x_min to x_max, the connecting structure is arranged between y_min and y_max or between x_min and x_max. The shape and design of the connecting structure depend on the respective parameters.

Embodiments of the present disclosure provide a measured value acquisition device for an inductive sensor arrangement having a circuit carrier comprising at least one receiving structure. The at least one receiving structure comprises at least one receiving coil having at least two windings. A single winding of the at least one receiving coil has in each case two loop structures with a plurality of loop sections and is formed in at least two planes of the circuit carrier. Portions of the individual loop structures arranged in different planes of the circuit carrier are electrically connected to each other via through-hole platings. The loop sections of the two loop structures of the individual windings have opposite flow directions. The loop structures of the at least two electrically series-connected windings of the at least one receiving coil are arranged offset with respect to one each other by a predetermined distance. In this case, ends of the individual loop structures of the at least two windings of the at least one receiving coil are each connected to each other at end regions of the corresponding receiving structure via at least one connecting structure such that an electrical series connection of at least two windings and/or a reversal of a flow direction is created within one of the at least two windings.

In addition, an inductive sensor arrangement for detecting a movement of a movable body, with at least one coupling device and such a measured value acquisition device, is proposed. In this case, the at least one coupling device or the measured value acquisition device is coupled to the movable body whose movement is to be detected. At least one exciter structure is arranged on a circuit carrier of the measured value acquisition device. The at least one exciter structure is coupled to at least one evaluation and control circuit, which couples a periodic alternating signal into the at least one exciter structure during operation. The at least one coupling device is designed to influence an inductive coupling between the at least one exciter structure and at least one receiving structure of the measured value acquisition device. The at least one evaluation and control unit is designed to receive and evaluate signals induced in the at least one receiving structure and to determine a current position of the movable coupling device relative to the at least one receiving structure and/or a current position of the movable body.

The inductive sensor arrangement can, for example, be designed as a linear displacement sensor, in which the movable body performs a translational movement to be detected along an axis of movement, or as a rotary angle sensor or rotor position sensor, in which the movable body performs a rotary movement to be detected around an rotation axis. In the case of an inductive rotation sensor, the measured value acquisition device can preferably have a space-saving “C” shape, which can be attached to a shaft. This can simplify the manufacturing concept for integrating the inductive sensor arrangement. A coil layout for such a measured value acquisition device can be determined by a suitable choice of origin (0, 0) by a coordinate transformation of polar coordinates of a coil layout of a measured value acquisition device for an inductive linear position sensor into Cartesian coordinates.

In the present case, an evaluation and control unit can be understood as an electrical assembly or electrical circuit that prepares, processes or evaluates recorded sensor signals. Preferably, the evaluation and control unit can be designed as an ASIC component (ASIC: application-specific integrated circuit). The evaluation and control unit can comprise at least one interface, which can be implemented as hardware and/or software. When implemented as hardware, the interfaces can be part of the ASIC component, for example. However, it is also possible that the interfaces are dedicated integrated circuits or consist at least partly of discrete components. When implemented as software, the interfaces can be software modules present, for example, on a microcontroller alongside other software modules.

In the following, the exciter structure can be understood as an exciter coil with a predetermined number of turns, which emits the alternating signal coupled in by the evaluation and control unit.

Advantageous improvements to the measured value acquisition devices for an inductive sensor arrangement set forth below are possible by way of the measures and further embodiments described below.

It is particularly advantageous that a number of the connecting structures can be based on a number of the windings of the at least one receiving coil. In this way, the electrical series connection of the windings of the at least one receiving coil can be systematically implemented.

In an advantageous embodiment of the measured value acquisition device, the at least one connecting structure can comprise a through-hole plating, which connects two individual loop structures of two windings or a common one of the at least two windings arranged in different planes. In this case, the two individual loop structures can end at the through-hole plating before the corresponding end of the receiving structure. As a result, the two loop structures are terminated “prematurely”, i.e. before reaching the end of the receiving structure. Preferably, the through-hole plating can be arranged in the region of an intersection point of the two individual loop structures arranged in different planes. Alternatively, the at least one connecting structure may comprise a conductor path piece which is connected at contact points in each case to one end of two individual loop structures of two windings arranged in the same plane or of a common one of the at least two windings and connects them to one another. If the windings to be connected “end” in the same plane of the printed circuit board, through-hole plating is not required, but a conductor path piece is sufficient. In this case, the two loop structures to be connected can be terminated “prematurely”, i.e. before reaching the end of the receiving structure, in order to create space within the receiving structure for applying the conductor path piece of the connecting structure. As a further alternative, the at least one connecting structure may comprise a through-hole plating and at least one conductor path piece in one of the two planes or in both planes and connect two individual loop structures of two windings or a common one of the at least two windings arranged in different planes. Due to the alternative design options of the connecting structure, it can be easily adapted to the structural conditions of the receiving structure. If the connecting structure connects the loop structures of two different windings of the receiving coil, then an electrical series connection of the two windings can be implemented, which preferably also results in the flow direction of the loop structures of the two windings connected as a result. If the connecting structure connects the loop structures from a common winding or from the same winding of the receiving coil, then a reversal of the flow direction within the winding can be implemented. A clear definition of the overall flow direction of a receiving coil is as a function of the polarity of the measurement of the induced signals. Therefore, a reversal of all flow directions is to be regarded as equivalent and merely dependent on the definition.

In a further advantageous embodiment of the measured value acquisition device, the through-hole plating can be connected in one plane to one end of one of the two loop structures and in the other plane to the at least one conductor path piece, which can be connected at a contact point to one end of the other of the two loop structures. The position of the through-hole plating can be shifted along the corresponding loop structure in order to terminate it before reaching the end of the receiving structure, as long as no short circuit or design rule violation occurs as a result. A design rule violation can be understood to mean, for example, falling below a minimum distance between the conductor path and through-hole plating and/or conductor path and conductor path. Alternatively, a first conductor path piece can be connected in one plane to the through-hole plating and at a contact point to one end of one of the loop structures, and a second conductor path piece can be connected in another plane to the through-hole plating and at a contact point to one end of the other of the two loop structures.

In a further advantageous embodiment of the measured value acquisition device, the loop sections of the two loop structures can each repeat periodically. Here, a complete period of the loop sections can correspond to a sinusoidal curve or a rectangular curve or a triangular curve and a number of the periodically repeating loop sections can define a periodicity of the receiving structure. Of course, the periodically repeating loop sections can also have other suitable shapes or mixed shapes. Due to the premature termination, the shape of the loop sections of the loop structures at the ends of the receiving structure may differ from the shape of the repeating loop sections of the loop structures in the remaining regions of the receiving structure.

In a further advantageous embodiment of the measured value acquisition device, the sections of the individual loop structures arranged in different planes of the circuit carrier can, for example, correspond to a half or a quarter or an eighth period of the repeating loop sections.

In another advantageous embodiment of the measured value acquisition device, a distance of adjacent loop structures of the at least one receiving structure can be based on the number of receiving structures and on a number of receiving coils and on a number of windings of the at least one receiving coil and on the periodicity of the at least one receiving structure. The distances between the loop structures of the windings of the at least one receiving coil of the same receiving structure can be the same. Equal spacing enables optimum utilization of the available installation space with regard to maximizing the number of turns in order to simultaneously avoid a design rule violation. Preferably, the loop structures of the individual windings of the at least one receiving coil can be designed to be almost congruent. Alternatively, the distances between the loop structures of the windings of the at least one receiving coil may differ, in particular if the at least one receiving coil has more than two windings.

In a further advantageous embodiment of the measured value acquisition device, loop structures of the windings of several receiving coils can be arranged alternately along the receiving structure. In other words, in the case of two receiving coils, a loop structure of a first receiving coil and then a loop structure of a second receiving coil can be arranged followed by a loop structure of the first receiving coil, etc. Alternatively, loop structures of the windings of several receiving coils can be arranged grouped along the receiving structure after the receiving coils. In other words, for three windings per receiving coil, first three loop structures of the individual windings of the first receiving coil and then three loop structures of the individual windings of the second receiving coil can be arranged followed by three loop structures of the individual windings of the first receiving coil, etc.

Exemplary embodiments of the disclosure are illustrated in the drawings and explained in more detail in the following description. In the drawings, identical reference numerals refer to components or elements performing identical or similar functions.

### BRIEF DESCRIPTION OF THE DRAWINGS

FIG. 1 shows a schematic plan view of a first exemplary embodiment of an inductive sensor arrangement according to the disclosure with a first exemplary embodiment of a measured value acquisition device according to the disclosure, wherein a circuit carrier of the measured value acquisition device is shown transparent.

FIG. 2 shows a schematic plan view of a first end region of the measured value acquisition device according to the disclosure from FIG. 1.

FIG. 3 shows a schematic perspective view of the first end region of the measured value acquisition device according to the disclosure from FIG. 2.

FIG. 4 shows a schematic plan view of a second end region of the measured value acquisition device according to the disclosure from FIG. 1.

FIG. 5 shows a schematic perspective view of the second end region of the measured value acquisition device according to the disclosure from FIG. 4.

FIG. 6 shows a schematic plan view of a second exemplary embodiment of an inductive sensor arrangement according to the disclosure with a second exemplary embodiment of a measured value acquisition device according to the disclosure, wherein a circuit carrier of the measured value acquisition device is shown transparent.

FIG. 7 shows a schematic plan view of a first end region of the measured value acquisition device according to the disclosure from FIG. 6.

FIG. 8 shows a schematic perspective view of the first end region of the measured value acquisition device according to the disclosure from FIG. 7.

FIG. 9 shows a schematic plan view of a second end region of the measured value acquisition device according to the disclosure from FIG. 6.

FIG. 10 shows a schematic perspective view of the second end region of the measured value acquisition device according to the disclosure from FIG. 9.

FIG. 11 shows a schematic plan view of a third exemplary embodiment of an inductive sensor arrangement according to the disclosure with a third exemplary embodiment of a measured value acquisition device according to the disclosure.

### DETAILED DESCRIPTION

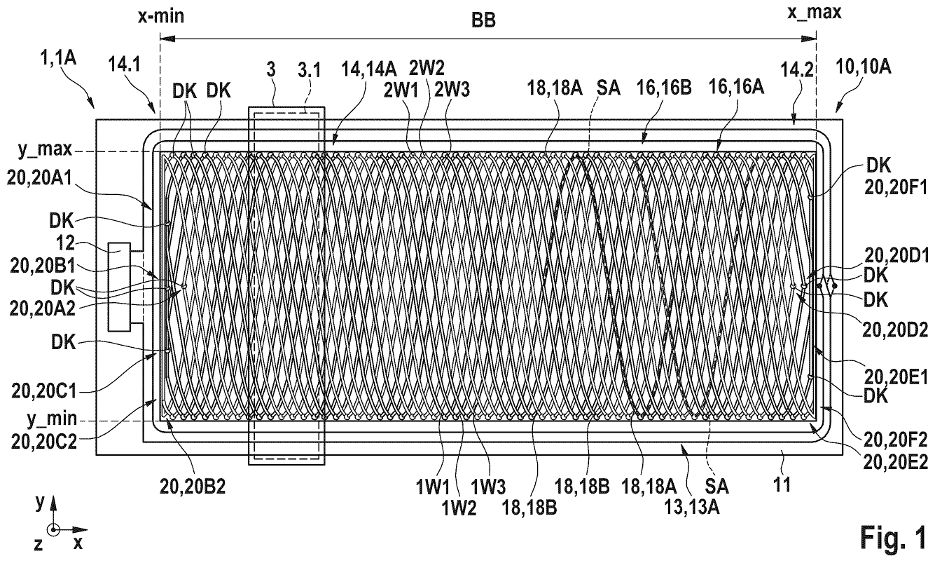

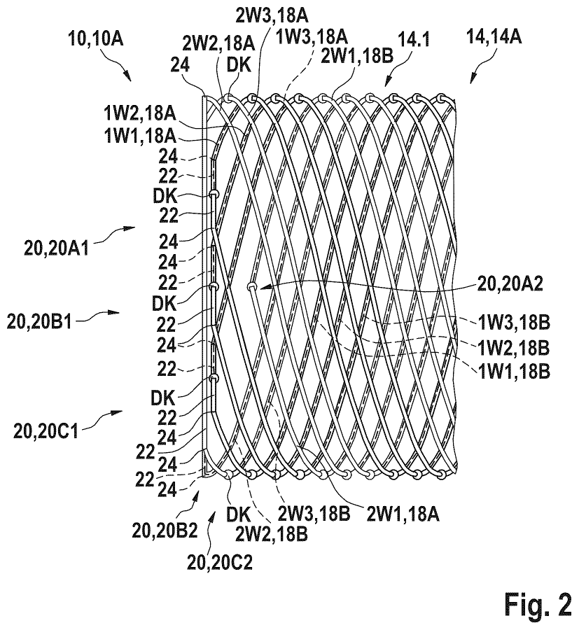

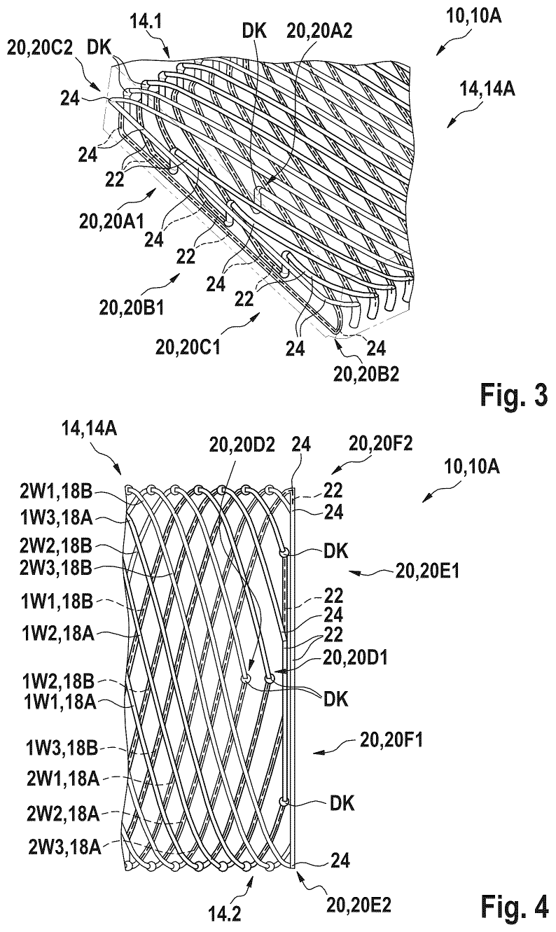

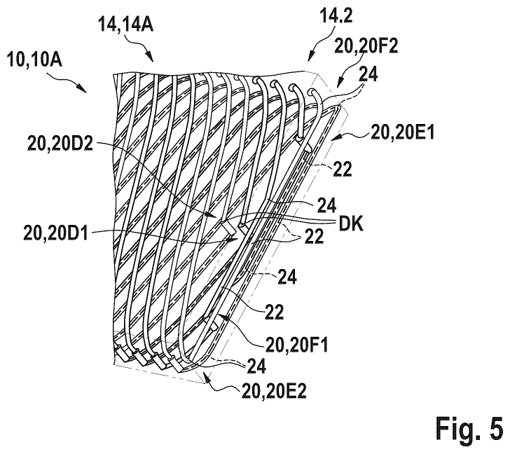

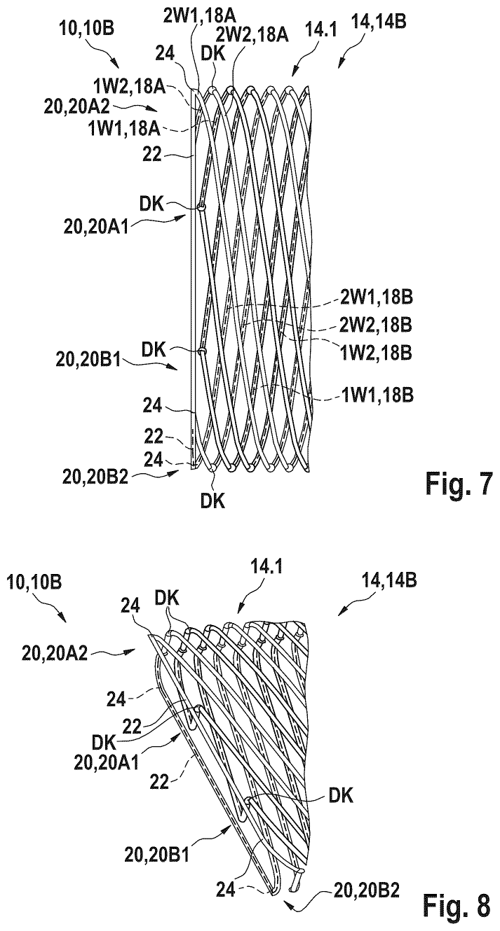

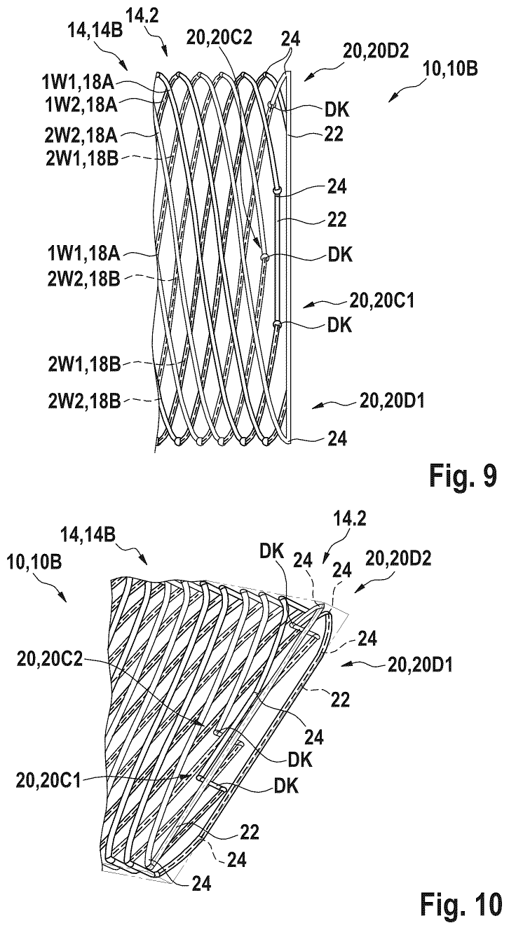

As FIGS. 1 to 11 show, the exemplary embodiments shown of a measured value acquisition device 10 for an inductive sensor arrangement 1 according to the disclosure comprise a circuit carrier 11 which comprises at least one receiving structure 14 which comprises at least one receiving coil 16 having at least two windings 1W1, 1W2, 1W3, 2W1, 2W2, 2W3. A single winding 1W1, 1W2, 1W3, 2W1, 2W2, 2W3 of the at least one receiving coil 16 has in each case two loop structures 18A, 18B with a plurality of loop sections SA and is formed in at least two planes of the circuit carrier 11. Sections of the individual loop structures 18A, 18B arranged in different planes of the circuit carrier 11 are electrically connected to each other via through-hole platings DK. The loop sections SA of the two loop structures 18A, 18B of the individual windings 1W1, 1W2, 1W3, 2W1, 2W2, 2W3 have opposite flow directions. The loop structures 18A, 18B of the at least two electrically series-connected windings 1W1, 1W2, 1W3, 2W1, 2W2, 2W3 of the at least one receiving coil 16 are arranged offset with respect to one each other by a predetermined distance. In this case, ends of the individual loop structures 18A, 18B of the at least two windings 1W1, 1W2, 1W3, 2W1, 2W2, 2W3 of the at least one receiving coil 16 are each connected to each other at end regions 14.1, 14.2 of the corresponding receiving structure 14 via at least one connecting structure 20 such that an electrical series connection of at least two windings 1W1, 1W2, 1W3, 2W1, 2W2, 2W3 and/or a reversal of a flow direction is created within one of the at least two windings 1W1, 1W2, 1W3, 2W1, 2W2, 2W3.

A number of the connecting structures 20 is based on a number of windings 1W1, 1W2, 1W3, 2W1, 2W2, 2W3 of the at least one receiving coil 16. As can be further seen from FIGS. 1 to 10, the loop sections SA of the two loop structures 18A, 18B are repeated periodically in each of the exemplary embodiments shown. A complete period of the periodically repeating loop sections SA corresponds to a sine curve or cosine curve. Alternatively, the periodically repeating loop sections SA can also correspond to a rectangular or triangular waveform. In addition, the sections of the individual loop structures 18A, 18B arranged in different planes of the circuit carrier 11 correspond to a half period of the repeating loop sections SA. Here, the through-hole platings DK, which connect the sections of the individual loop structures 18A, 18B arranged on a lower plane of the circuit carrier 11 in the embodiments, to the sections of the individual loop structures 18A, 18B arranged on an upper plane of the circuit carrier 11 in the embodiments, are each arranged on an upper edge of the receiving structure 14 in the embodiments and on a lower edge of the receiving structure 14 in the embodiments In the exemplary embodiments of the measured value acquisition device 10 shown, the two loop structures 18A, 18B of the at least one receiving coil 16 are arranged offset with respect to one each other by 180° and the flow direction runs in a first loop structure 18A of the at least two electrically series-connected windings 1W1, 1W2, 1W3, 2W1, 2W2, 2W3 of the at least one receiving coil 16 in the positive x-direction (here from left to right) and in a second loop structure 18B of the at least two electrically series-connected windings 1W1, 1W2, 1W3, 2W1, 2W2, 2W3 of the at least one receiving coil 16 in the negative x-direction (here from right to left). Due to the two loop structures 18A, 18B arranged offset with respect to one another by half a period or by 180° along the path of movement BB with opposite directions of passage, surfaces are enclosed between the first loop structure 18A and the second loop structure 18B of the at least two windings 1W1, 1W2, 1W3, 2W1, 2W2, 2W3 of the at least one receiving coil 16 in each case, which have a different surface normal. Depending on the periodicity of the windings 1W1, 1W2, 1W3, 2W1, 2W2, 2W3 of the at least one receiving coil 16, a corresponding number of pairs of areas are included between the two loop structures 18A, 18B of the at least two windings W1, W2 connected electrically in series. Alternatively, the sections of the individual loop structures 18A, 18B arranged in different planes of the circuit carrier 11 may correspond to a quarter or an eighth period. Due to the premature termination, the shape of the loop sections SA of the loop structures 18A, 18B at the ends of the receiving structure 14 may differ from the shape of the repeating loop sections SA of the loop structures 18A, 18B in the remaining regions of the receiving structure 14.

As can be further seen from FIGS. 1 to 11, the spacing of adjacent loop structures 18A, 18B of the at least one receiving structure 14 is based on a number of receiving structures 14 and on a number of receiving coils 16 and on a number of windings 1W1, 1W2, 1W3, 2W1, 2W2, 2W3 of the at least one receiving coil 16 and on the periodicity of the at least one receiving structure 14 and therefore differs in the various exemplary embodiments of the measured value acquisition device 10 shown. In the illustrated exemplary embodiments of the measured value acquisition device 10, the distances between the loop structures 18A, 18B of windings 1W1, 1W2, 1W3, 2W1, 2W2, 2W3 of the at least one receiving coil 16 of the same receiving structure 14 are equal. In addition, the loop structures 18A, 18B of the windings 1W1, 1W2, 1W3, 2W1, 2W2, 2W3 of a plurality of receiving coils 16 are arranged grouped along the receiving structure 14 after the receiving coils 16.

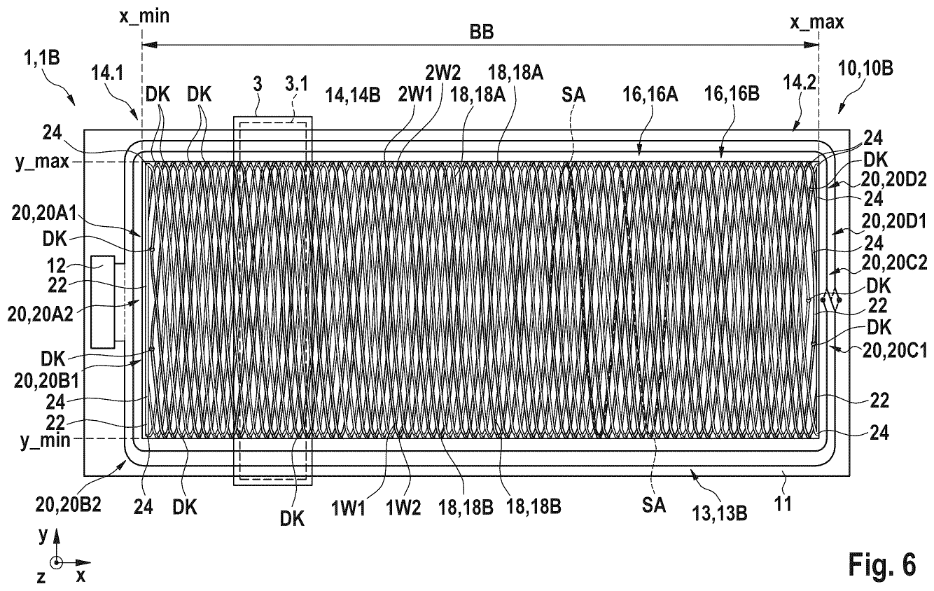

As can also be seen from FIGS. 1 and 6, the inductive sensor arrangement 1 in each of the exemplary embodiments shown is designed as an inductive linear displacement sensor and comprises at least one coupling device 3 and a measured value acquisition device 10 according to the disclosure for detecting a movement of a movable body not shown. In this case, the at least one coupling device 3 or the measured value acquisition device 10 is coupled to the movable body not shown, whose linear movement along the movement path BB is to be detected. At least one exciter structure 13 is arranged on a circuit carrier 11 of the measured value acquisition device 10. The at least one exciter structure 13 is coupled to at least one evaluation and control circuit 12, which couples a periodic alternating signal into the at least one exciter structure 13 during operation. The at least one coupling device 3 comprises an electrically conductive coupling element 3.1 and is designed to influence an inductive coupling between the at least one exciter structure 13 and at least one receiving structure 14 of the measured value acquisition device 10. The at least one evaluation and control unit 12 is designed to receive and evaluate signals induced in the at least one receiving structure 14 and to determine a current relative position of the movable coupling device 3 to the at least one receiving structure 14 and/or a current position of the movable body. As can be further seen from FIGS. 1 and 6, the receiving structure 14 extends in a first direction y from y_min to y_max and in a second direction x along a path of movement BB of the coupling device 3 from x_min to x_max and spans a corresponding plane between (y_max−y_min) and (x_max−x_min).]

For the sake of clarity, an electrical connection of the at least one receiving coil 16 of the at least one receiving structure 14 to the evaluation and control unit 12 is not shown in FIGS. 1 to 11. This does not represent a short circuit of the at least one receiving coil 16. Of course, the at least one receiving coil 16 can be disconnected at a suitable point, for example at a through-hole plating DK, and routed through additional conductor paths to the evaluation and control unit 12, so that the induced signals can be evaluated there.

As is further evident from FIGS. 1 to 5, a first exemplary embodiment of the inductive sensor arrangement 1A according to the disclosure comprises a first exemplary embodiment of the measured value acquisition device 10A, which comprises a receiving structure 14A, and the exciter structure 13, which in the illustrated first exemplary embodiment of the inductive sensor arrangement 1A comprises an exciter coil 13A with four windings arranged in two planes of the circuit carrier 11. This means that two windings are arranged in each plane of the circuit carrier 11. The receiving structure 14A comprises two receiving coils 16A, 16B, which each have three windings 1W1, 1W2, 1W3, 2W1, 2W2, 2W3 and are formed in two planes of the circuit carrier 11. A first receiving coil 16A forms a sine channel and a second receiving coil 16B forms a cosine channel. The individual windings 1W1, 1W2, 1W3, 2W1, 2W2, 2W3 of the two receiving coils 16A, 16B each have two loop structures 18A, 18B, each with five loop sections SA. The loop sections SA of the two loop structures 18A, 18B of the individual windings 1W1, 1W2, 1W3, 2W1, 2W2, 2W3 have a sinusoidal shape and opposite flow directions in the exemplary embodiment shown. The loop structures 18A, 18B of the three electrically series-connected windings 1W1, 1W2, 1W3, 2W1, 2W2, 2W3 of the two receiving coils 16A, 16B are arranged offset with respect to one each other by a predetermined distance. In this case, ends of the individual loop structures 18A, 18B of the three windings 1W1, 1W2, 1W3, 2W1, 2W2, 2W3 of the two receiving coils 16A, 16B are each connected to each other at end regions 14.1, 14.2 of the receiving structure 14A via three connecting structures 20A1, 20B1, 20C1, 20D1, 20E1, 20F1, 20A2, 20B2, 20C2, 20D2, 20E2, 20F2 such that in each case an electrical series connection of the three windings 1W1, 1W2, 1W3, 2W1, 2W2, 2W3 of the two receiving coils 16A, 16B and/or a reversal of the flow direction within one of the three windings 1W1, 1W2, 1W3, 2W1, 2W2, 2W3 is created.

As can be further seen from FIGS. 1 to 3, a first connecting structure 20A1, a second connecting structure 20B1 and a third connecting structure 20C1 of the first receiving coil 16A each comprise a through-hole plating DK at a first end 14.1 of the receiving structure 14A and two straight conductor path pieces 22 in two planes of the circuit carrier 11. Here, the first connecting structure 20Al connects a second loop structure 18B of a third winding 1W3 of the first receiving coil 16A to a first loop structure 18A of a first winding 1W1 of the first receiving coil 16A. For this purpose, a straight conductor path piece 22 arranged on an upper plane of the circuit carrier 11 in the y-direction in the representation is connected with a first end to a contact point 24, with a premature end of the second loop structure 18B of the third winding 1W3 and with a second end to the through-hole plating DK. A straight conductor path piece 22 arranged on a lower plane of the circuit carrier 11 in the y-direction in the representation is connected with a first end at a contact point 24 to a premature end of the first loop structure 18A of the first winding 1W1 and with a second end to the through-hole plating DK. The second connecting structure 20B1 of the first receiving coil 16A connects a second loop structure 18B of a second winding 1W2 to a first loop structure 18A of the second winding 1W2. For this purpose, a straight conductor path piece 22 arranged on an upper plane of the circuit carrier 11 in the y-direction in the representation is connected with a first end at a contact point 24 to a premature end of the second loop structure 18B of the second winding 1W2 and with a second end to the through-hole plating DK. A straight conductor path piece 22 arranged on a lower plane of the circuit carrier 11 in the y-direction is connected with a first end at a contact point 24 to a premature end of the first loop structure 18A of the second winding 1W2 and with a second end to the through-hole plating DK. The third connecting structure 20C1 of the first receiving coil 16A connects a second loop structure 18B of the first winding 1W1 to a first loop structure 18A of the third winding 1W3. For this purpose, a straight conductor path piece 22 arranged on an upper plane of the circuit carrier 11 in the y-direction in the representation is connected with a first end at a contact point 24 to a premature end of the second loop structure 18B of the first winding 1W1 and with a second end to the through- hole plating DK. A straight conductor path piece 22 arranged on a lower plane of the circuit carrier 11 in the y-direction is connected with a first end at a contact point 24 to a premature end of the first loop structure 18A of the third winding 1W3 and with a second end to the through-hole plating DK.

As can be further seen from FIGS. 1 to 3, a first connecting structure 20A2 of the second receiving coil 16B comprises a through-hole plating DK at the first end 14.1 of the receiving structure 14A, which connects two individual loop structures 18A, 18B of a first winding 2W1 of the second receiving coil 16B arranged in different planes of the circuit carrier 11. Here, a second loop structure 18B of the first winding 2W1 of the second receiving coil 16B ends before the first end 14.1 of the receiving structure 14A at the through-hole plating DK. A first loop structure 18A of the first winding 2W1 of the second receiving coil 16B also terminates before the first end 14.1 of the receiving structure 14A at the through-hole plating DK. A second connecting structure 20B2 and a third connecting structure 20C2 of the second receiving coil 16A each comprise a straight conductor path piece 22 extending in the y-direction, which are each connected at contact points 24 to one end of two individual loop structures 18A, 18B arranged in the same plane of the circuit carrier 11. For this purpose, the straight conductor path piece 22 of the second connecting structure 20B2 extending in the y-direction is connected in the lower plane of the circuit carrier 11 with a first end at a contact point 24, which replaces a through-hole plating DK, to one end of a second loop structure 18B of a second winding 2W2 of the second receiving coil 16B and with a second end at a contact point 24 to one end of a first loop structure 18A of a third winding 2W3 of the second receiving coil 16B. The straight conductor path piece 22 of the third connecting structure 20C2 extending in the y-direction is connected in the upper plane of the circuit carrier 11 with a first end at a contact point 24 to one end of a second loop structure 18B of the third winding 2W3 of the second receiving coil 16B and with a second end at a contact point 24, which replaces a through-hole plating, to one end of a first loop structure 18A of the second winding 2W2 of the second receiving coil 16B.

As can be further seen from FIGS. 1, 4 and 5, a fourth connecting structure 20D1 of the first receiving coil 16A comprises a through-hole plating DK at the second end 14.2 of the receiving structure 14A, which connects a second loop structure 18B of the first winding 1W1 of the first receiving coil 16A arranged in the upper plane of the circuit carrier 11 to the first loop structure 18A of the first winding 1W1 of the first receiving coil 16A arranged in the lower plane of the circuit carrier 11. Here, the first loop structure 18A and the second loop structure 18B of the first winding 1W1 of the first receiving coil 16A each end prematurely before the second end 14.2 of the receiving structure 14A at the through-hole plating DK. A fifth connecting structure 20E1 and a sixth connecting structure 20F1 of the first receiving coil 16A each comprise a through-hole plating DK and a conductor path piece 22 at the second end 14.2 of the receiving structure 14A. Here, the fifth connecting structure 20E1 connects the second loop structure 18B of the third winding 1W3 of the first receiving coil 16A to the first loop structure 18A of the third winding 1W3 of the first receiving coil 16A. For this purpose, an end of the second loop structure 18B arranged on the upper level of the circuit carrier 11 is connected to the through-hole plating and ends prematurely at the through-hole plating DK. A straight conductor path piece 22 arranged on the lower level of the circuit carrier 11 and extending in the y-direction is connected with a first end at a contact point 24 to a premature end of the first loop structure 18A of the third winding 1W3 of the first receiving coil 16A and with a second end to the through-hole plating DK. The sixth connecting structure 20F1 of the first receiving coil 16A connects a second loop structure 18B of the second winding 1W2 to the first loop structure 18A of the third winding 1W3. For this purpose, a straight conductor path piece 22 arranged on the upper level of the circuit carrier 11 and extending in the y-direction is connected with a first end at a contact point 24 to a premature end of the second loop structure 18B of the second winding 1W2 and with a second end to the through-hole plating DK. An end of the first loop structure 18A of the third winding 1W3 arranged on the lower plane of the circuit carrier 11 is connected to the through-hole plating DK and ends prematurely at the through-hole plating.

As can be further seen from FIGS. 1, 4 and 5, a fourth connecting structure 20D2 of the second receiving coil 16B comprises a through-hole plating DK at the second end 14.2 of the receiving structure 14A, which connects a second loop structure 18B of the third winding 2W3 of the second receiving coil 16B arranged in the upper plane of the circuit carrier 11 to the first loop structure 18A of the third winding 2W3 of the second receiving coil 16B arranged in the lower plane of the circuit carrier 11. Here, the first loop structure 18A and the second loop structure 18B of the third winding 2W3 of the second receiving coil 16B each end prematurely before the second end 14.2 of the receiving structure 14A at the through-hole plating DK. A fifth connecting structure 20E2 and a sixth connecting structure 20F2 of the second receiving coil 16B each comprise a straight conductor path piece 22 extending in the y-direction at the second end 14.2 of the receiving structure 14A, which are each connected at contact points 24 to one end of two individual loop structures 18A, 18B arranged in the same plane of the circuit carrier 11. For this purpose, the straight conductor path piece 22 of the fifth connecting structure 20E2 extending in the y-direction is connected in the upper plane of the circuit carrier 11 with a first end at a contact point 24 to the end of the first loop structure 18A of the first winding 2W1 of the second receiving coil 16B and with a second end at a contact point 24, which replaces a through-hole plating DK, to an end of the second loop structure 18B of the second winding 2W2 of the second receiving coil 16B. The straight conductor path piece 22 of the sixth connecting structure 20F2 extending in the y-direction is connected in the lower plane of the circuit carrier 11 with a first end at a contact point 24, which replaces a through-hole plating DK, to one end of the first loop structure 18A of the second winding 2W2 of the second receiving coil 16B and with a second end at a contact point 24 to one end of a second loop structure 18A of the first winding 2W1 of the second receiving coil 16B.

As can be further seen from FIGS. 6 to 10, a second exemplary embodiment of the inductive sensor arrangement 1B according to the disclosure comprises a second exemplary embodiment of a measured value acquisition device 10B, which comprises a receiving structure 14B, and the exciter structure 13, which in the illustrated second exemplary embodiment of the inductive sensor arrangement 1B also comprises an exciter coil 13B with two windings arranged in two planes of the circuit carrier 11. The receiving structure 14B comprises two receiving coils 16A, 16B, which each have two windings 1W1, 1W2, 2W1, 2W2 and are formed in two planes of the circuit carrier 11. A first receiving coil 16A forms a sine channel and a second receiving coil 16B forms a cosine channel. The individual windings 1W1, 1W2, 2W1, 2W2 of the two receiving coils 16A, 16B each have two loop structures 18A, 18B, each with ten loop sections SA. The loop sections SA of the two loop structures 18A, 18B of the individual windings 1W1, 1W2, 2W1, 2W2 have a sinusoidal shape and opposite flow directions in the exemplary embodiment shown. The loop structures 18A, 18B of the two electrically series-connected windings 1W1, 1W2, 2W1, 2W2 of the two receiving coils 16A, 16B are arranged offset with respect to one each other by a predetermined distance. In this case, ends of the individual loop structures 18A, 18B of the two windings 1W1, 1W2, 2W1, 2W2 of the two receiving coils 16A, 16B are each connected to each other at end regions 14.1, 14.2 of the receiving structure 14B via two connecting structures 20A1, 20B1, 20C1, 20D1, 20A2, 20B2, 20C2, 20D2, such that in each case an electrical series connection of the two windings 1W1, 1W2, 2W1, 2W2 of the two receiving coils 16A, 16B and/or a reversal of the flow direction within one of the three windings 1W1, 1W2, 2W1, 2W2 is created.

As can be further seen from FIGS. 6 to 8, a first connecting structure 20A1 and a second connecting structure 20B1 of the first receiving coil 16A each comprise a through-hole plating DK at a first end 14.1 of the receiving structure 14B. Here, the first connecting structure 20A1 connects a second loop structure 18B of a second winding 1W2 of the first receiving coil 16A to a first loop structure 18A of a first winding 1W1 of the first receiving coil 16A. Therefore, the second loop structure 18B of the second winding 1W2 and the first loop structure 18A of the first winding 1W1 of the first receiving coil 16A each terminate prematurely before the first end 14.1 of the receiving structure 14A at the through-hole plating DK. The second connecting structure 20B1 connects a second loop structure 18B of the first winding 1W1 of the first receiving coil 16A to a first loop structure 18A of the second winding 1W2 of the first receiving coil 16A. Therefore, the second loop structure 18B of the first winding 1W1 and the first loop structure 18A of the second winding 1W2 of the first receiving coil 16A each terminate prematurely before the first end 14.1 of the receiving structure 14A at the through-hole plating DK.

As can be further seen from FIGS. 6 to 8, a first connecting structure 20A2 and a second connecting structure 20B2 of the second receiving coil 16B each comprise a straight conductor path piece 22 extending in the y-direction at a first end 14.1 of the receiving structure 14B, which are each connected at contact points 24 to one end of two individual loop structures 18A, 18B arranged in the same plane of the circuit carrier 11. For this purpose, the straight conductor path piece 22 of the first connecting structure 20A2 extending in the y-direction is connected in the upper plane of the circuit carrier 11 with a first end at a contact point 24, which replaces a through-hole plating DK, to one end of a first loop structure 18A of the first winding 2W1 of the second receiving coil 16B and with a second end at a contact point 24 to one end of the second loop structure 18B of the second winding 2W2 of the second receiving coil 16B. The straight conductor path piece 22 of the second connecting structure 20B2 extending in the y-direction is connected in the lower plane of the circuit carrier 11 with a first end at a contact point 24 to one end of a first loop structure 18A of the second winding 2W2 of the second receiving coil 16B and with a second end at a contact point 24, which replaces a through-hole plating DK, to one end of a second loop structure 18B of the first winding 2W1 of the second receiving coil 16B.

As can be further seen from FIGS. 6, 9 and 10, a third connecting structure 20C1 of the first receiving coil 16A comprises a through-hole plating DK and a straight conductor path piece 22 extending in the y-direction at the second end 14.2 of the receiving structure 14B. Here, the third connecting structure 20C1 connects the second loop structure 18B of the first winding 1W1 of the first receiving coil 16A to the first loop structure 18A of the first winding 1W1 of the first receiving coil 16A. For this purpose, an end of the first loop structure 18A arranged on the lower level of the circuit carrier 11 is connected to the through-hole plating DK and ends prematurely at the through-hole plating DK. A straight conductor path piece 22 arranged on the upper level of the circuit carrier 11 and extending in the y-direction is connected with a first end at a contact point 24 to a premature end of the second loop structure 18B of the first winding 1W1 of the first receiving coil 16A and with a second end to the through-hole plating DK. In addition, a through-hole plating DK of the second loop structure 18B of the second winding 1W2 of the first receiving coil 16A is replaced by a contact point 24, so that a portion of the second loop structure 18B actually extending in the upper plane of the circuit carrier 11 continues to extend in the lower plane of the circuit carrier 11. Therefore, a fourth connecting structure 20D1 of the first receiving coil 16A at the second end 14.2 of the receiving structure 14B comprises only a straight conductor path piece 22 extending in the y-direction and connects the second loop structure 18B of the second winding 1W2 of the first receiving coil 16A to the first loop structure 18A of the second winding 1W2 of the first receiving coil 16A. For this purpose, a straight conductor path piece 22 extending in the y-direction on the lower plane of the circuit carrier 11 is connected with a first end at a contact point 24 to one end of the second loop structure 18B of the second winding 1W2 of the first receiving coil 16A and with a second end at a contact point 24 to one end of the first loop structure 18A of the second winding 1W2 of the first receiving coil 16A.

As can be further seen from FIGS. 6, 9 and 10, a third connecting structure 20C2 of the second receiving coil 16B comprises a through-hole plating DK at the second end 14.2 of the receiving structure 14B, which connects two individual loop structures 18A, 18B of the second winding 2W2 of the second receiving coil 16B arranged in different planes of the circuit carrier 11. Here, the second loop structure 18B and the first loop structure 18A of the second winding 2W2 of the second receiving coil 16B each end prematurely before the second end 14.2 of the receiving structure 14B at the through-hole plating DK. In addition, a through-hole plating DK of the first loop structure 18A of the first winding 1W1 of the second receiving coil 16B is offset from the upper edge of the receiving structure 14B along the first loop structure 18A in the negative x-direction and in the negative y-direction, such that a portion of the first loop structure 18A is arranged in the upper plane of the circuit carrier 11 instead of in the lower plane of the circuit carrier 11, wherein a contact point 24 replaces the through-hole plating at the upper edge of the receiving structure 14B. Furthermore, a through-hole plating DK of the second loop structure 18B of the first winding 2W1 of the second receiving coil 16B at the lower edge of the receiving structure 14B is replaced by a contact point 24. Therefore, a fourth connecting structure 20D2 of the second receiving coil 16B at the second end 14.2 of the receiving structure 14B comprises only a straight conductor path piece 22 extending in the y-direction and connects the second loop structure 18B of the first winding 2W1 of the second receiving coil 16B to the first loop structure 18A of the first winding 2W1 of the second receiving coil 16B. For this purpose, a straight conductor path piece 22 extending in the y-direction on the upper plane of the circuit carrier 11 is connected with a first end at the contact point 24 at the upper edge of the receiving structure 14B to one end of the first loop structure 18A of the first winding 2W1 of the second receiving coil 16B and with a second end at the contact point 24 at the lower edge of the receiving structure 14B to one end of the second loop structure 18B of the first winding 2W1 of the second receiving coil 16B.

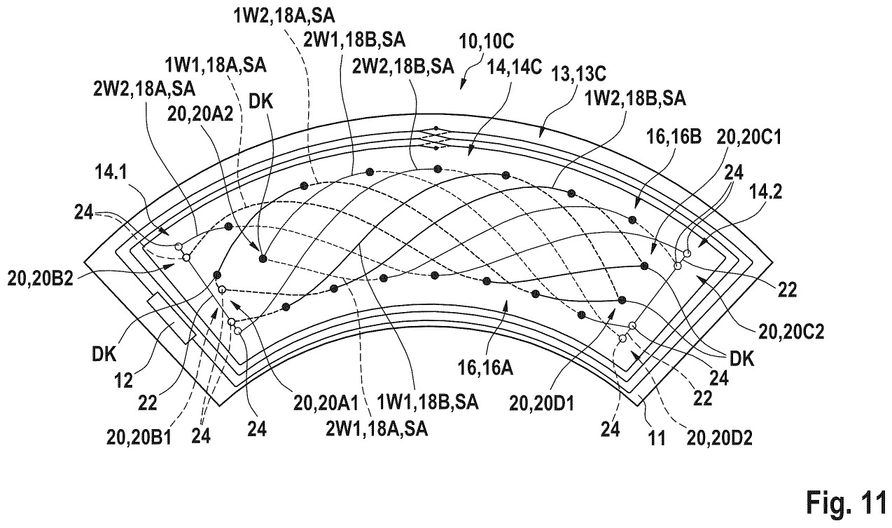

As can also be seen from FIG. 11, the inductive sensor arrangement 1C in the third exemplary embodiment shown is designed as an inductive angle of rotation sensor or rotor position sensor, in which the movable body not shown performs a rotational movement to be detected about a rotation axis. Analogous to the exemplary embodiments described above, the inductive sensor arrangement 1C for detecting a movement of a movable body not shown comprises at least one coupling device not shown in more detail and a measured value acquisition device 10C according to the disclosure, which in the third exemplary embodiment of the inductive sensor arrangement 1C shown has a space-saving “C” shape that can be plugged onto a shaft. Here, the at least one coupling device 3 or the measured value acquisition device 10C is coupled to the not shown movable body whose rotational movement is to be detected. At least one exciter structure 13 is arranged on a circuit carrier 11 of the measured value acquisition device 10C. The at least one exciter structure 13 is coupled to one evaluation and control circuit 12, which couples a periodic alternating signal into the at least one exciter structure 13 during operation. The at least one coupling device comprises an electrically conductive coupling element and is designed to influence an inductive coupling between the at least one exciter structure 13 and at least one receiving structure 14 of the measured value acquisition device 10C. The at least one evaluation and control unit 12 is designed to receive and evaluate signals induced in the at least one receiving structure 14 and to determine a current relative position of the movable coupling device to the at least one receiving structure 14 and/or a current position of the movable body.

As can be further seen from FIG. 11, the illustrated third exemplary embodiment of the measured value acquisition device 10C comprises a receiving structure 14C, and the exciter structure 13, which in the illustrated third exemplary embodiment of the inductive sensor arrangement 1C comprises an exciter coil 13C with six windings arranged in two planes of the circuit carrier 11. This means that three windings are arranged in each plane of the circuit carrier 11. The receiving structure 14C comprises two receiving coils 16A, 16B, which each have two windings 1W1, 1W2, 2W1, 2W2 and are formed in two planes of the circuit carrier 11. A first receiving coil 16A forms a sine channel and a second receiving coil 16B forms a cosine channel. The individual windings 1W1, 1W2, 2W1, 2W2 of the two receiving coils 16A, 16B each have two loop structures 18A, 18B, which each form a loop section SA. The loop sections SA or the two loop structures 18A, 18B of the individual windings 1W1, 1W2, 2W1, 2W2 each have a sinusoidal shape and opposite flow directions in the exemplary embodiment shown. The loop structures 18A, 18B of the two electrically series-connected windings 1W1, 1W2, 2W1, 2W2 of the two receiving coils 16A, 16B are arranged offset with respect to one each other by a predetermined distance. In this case, ends of the individual loop structures 18A, 18B of the two windings 1W1, 1W2, 2W1, 2W2 of the two receiving coils 16A, 16B are each connected to each other at end regions 14.1, 14.2 of the receiving structure 14B via two connecting structures 20A1, 20B1, 20C1, 20D1, 20A2, 20B2, 20C2, 20D2, such that in each case an electrical series connection of the two windings 1W1, 1W2, 2W1, 2W2 of the two receiving coils 16A, 16B and/or a reversal of the flow direction within one of the three windings 1W1, 1W2, 2W1, 2W2 is created.

As can be further seen from FIG. 11, a first connecting structure 20A1 of the first receiving coil 16A comprises a straight conductor path piece 22 and a through-hole plating DK at a first end 14.1 of the receiving structure 14C. Here, the first connecting structure 20A1 of the first receiving coil 16A connects a second loop structure 18B of the second winding 1W2 to the first loop structure 18A of the second winding 1W2 of the first receiving coil 16A. For this purpose, the straight conductor path piece 22 of the first connecting structure 20A1 in the lower plane of the circuit carrier 11 is connected with a first end at a contact point 24 to a premature end of the second loop structure 18B of the second winding 1W2 of the first receiving coil 16A and with a second end to the through-hole plating DK. One end of the first loop structure 18A of the second winding 1W2 of the first receiving coil 16A, which is arranged in the upper plane of the circuit carrier 11, is connected to the through-hole plating DK and ends there prematurely before the first end 14.1 of the receiving structure 14C. A second connecting structure 20B1 of the first receiving coil 16A comprises a straight conductor path piece 22 at the first end 14.1 of the receiving structure 14C. Here, the second connecting structure 20B1 of the first receiving coil 16A connects the second loop structure 18B of the first winding 1W1 to the first loop structure 18A of the first winding 1W1 of the first receiving coil 16A. For this purpose, the straight conductor path piece 22 of the second connecting structure 20B1 is connected in the lower plane of the circuit carrier 11 with a first end at a contact point 24 to one end of the second loop structure 18B of the first winding 1W1 of the first receiving coil 16A and with a second end at a contact point 24 to one end of the first loop structure 18A of the first winding. Here, a through-hole plating DK on the first loop structure 18A of the first winding 1W1 of the first receiving coil 16A was omitted at the upper edge of the receiving structure 14C so that the end of the first loop structure 18A is not continued in the upper plane of the circuit carrier 11 but in the lower plane of the circuit carrier 11.

As can be further seen from FIG. 11, a first connecting structure 20A2 of the second receiving coil 16B comprises a through-hole plating DK at the first end 14.1 of the receiving structure 14C. Here, the first connecting structure 20A2 of the second receiving coil 16B connects a second loop structure 18B of a first winding 2W1 of the second receiving coil 16B to a first loop structure 18A of the first winding 2W1 of the second receiving coil 16B. For this purpose, the end of the first loop structure 18A of the first winding 2W1 of the second receiving coil 16B, which is guided in the lower plane of the circuit carrier 11, is connected to the through-hole plating DK and ends there prematurely before the first end 14.1 of the receiving structure 14C. One end of the second loop structure 18B of the first winding 2W1 of the second receiving coil 16B, which is arranged in the upper plane of the circuit carrier 11, is connected to the through-hole plating DK and ends there prematurely before the first end 14.1 of the receiving structure 14C. A second connecting structure 20B2 of the first receiving coil 16A comprises a straight conductor path piece 22 at the first end 14.1 of the receiving structure 14C. Here, the second connecting structure 20B2 of the second receiving coil 16B connects the first loop structure 18A of the second winding 2W2 to the second loop structure 18B of the second winding 2W2 of the second receiving coil 16B. For this purpose, the straight conductor path piece 22 of the second connecting structure 20B2 is connected in the upper plane of the circuit carrier 11 with a first end at a contact point 24, which replaces a through-hole plating DK, to one end of the first loop structure 18A of the second winding 2W2 of the second receiving coil 16B and with a second end at a contact point 24, which also replaces a through-hole plating DK, to one end of the second loop structure 18B of the second winding. Here, the through-hole plating DK arranged at the upper edge of the receiving structure 14C at the first loop structure 18A of the second winding 2W2 was shifted to the right in the direction of the first loop structure 18A so that the end of the first loop structure 18A is not continued in the lower plane of the circuit carrier 11 but in the upper plane of the circuit carrier 11.

As can be further seen from FIG. 11, a third connecting structure 20C1 and a fourth connecting structure 20D1 of the first receiving coil 16A each comprise a through-hole plating DK at the second end 14.2 of the receiving structure 14C. Here, the third connecting structure 20C1 of the first receiving coil 16A connects a first loop structure 18A of the first winding 1W1 of the first receiving coil 16A to a second loop structure 18B of the second winding 1W2 of the first receiving coil 16A. For this purpose, the end of the second loop structure 18B of the second winding 1W2 of the first receiving coil 16A, which is guided in the lower plane of the circuit carrier 11, is connected to the through-hole plating DK and ends there prematurely before the second end 14.2 of the receiving structure 14C. One end of the first loop structure 18A of the first winding 1W1 of the first receiving coil 16A, which is arranged in the upper plane of the circuit carrier 11, is connected to the through-hole plating DK and ends there prematurely before the second end 14.2 of the receiving structure 14C. The fourth connecting structure 20D1 of the first receiving coil 16A connects a first loop structure 18A of the second winding 1W2 of the first receiving coil 16A to a second loop structure 18B of the first winding 1W1 of the first receiving coil 16A. For this purpose, the end of the second loop structure 18B of the first winding 1W1 of the first receiving coil 16A, which is guided in the lower plane of the circuit carrier 11, is connected to the through-hole plating DK and ends there prematurely before the second end 14.2 of the receiving structure 14C. One end of the first loop structure 18A of the second winding 1W2 of the first receiving coil 16A, which is arranged in the upper plane of the circuit carrier 11, is connected to the through-hole plating DK and ends there prematurely before the second end 14.2 of the receiving structure 14C.

As can be further seen from FIG. 11, a third connecting structure 20C2 and a fourth connecting structure 20D2 of the second receiving coil 16B each comprise a straight conductor path piece 22 at the second end 14.2 of the receiving structure 14C. Here, the third connecting structure 20C2 of the second receiving coil 16B connects the first loop structure 18A of the second winding 2W2 to the second loop structure 18B of the first winding 2W1 of the second receiving coil 16B. For this purpose, the straight conductor path piece 22 of the third connecting structure 20C2 is connected in the upper plane of the circuit carrier 11 with a first end at a contact point 24, which replaces a through-hole plating DK, to one end of the first loop structure 18A of the second winding 2W2 of the second receiving coil 16B and with a second end at a contact point 24 to one end of the second loop structure 18B of the first winding 2W1 of the second receiving coil 16B. The fourth connecting structure 20D2 of the second receiving coil 16B connects the first loop structure 18A of the first winding 2W1 to the second loop structure 18B of the second winding 2W2 of the second receiving coil 16B. For this purpose, the straight conductor path piece 22 of the fourth connecting structure 20D2 is connected in the lower plane of the circuit carrier 11 with a first end at a contact point 24 to one end of the first loop structure 18A of the first winding 2W1 of the second receiving coil 16B and with a second end at a contact point 24, which replaces a through-hole plating DK, to one end of the second loop structure 18B of the second winding 2W2 of the second receiving coil 16B.

What is claimed is:

1. A measured value acquisition device for an inductive sensor arrangement having a circuit carrier which comprises at least one receiving structure which comprises at least one receiving coil having at least two windings, wherein:
a single winding of the at least one receiving coil each has two loop structures with a plurality of loop sections and is formed in at least two planes of the circuit carrier,
sections of the individual loop structures arranged in different planes of the circuit carrier are electrically connected to each other via through-hole platings,
the loop sections of the two loop structures of the individual windings have opposite flow directions,
the loop structures of the at least two electrically series-connected windings of the at least one receiving coil are arranged offset with respect to one another by a predetermined distance, and
ends of the individual loop structures of the at least two windings of the at least one receiving coil are connected to each other at end regions of the corresponding receiving structure via at least one connecting structure such that an electrical series connection of at least two windings and/or a reversal of a flow direction within one of the at least two windings is created.

2. The measured value acquisition device according to claim 1, wherein a number of the connecting structures is based on a number of windings of the at least one receiving coil.

3. The measured value acquisition device according to claim 1, wherein:
at least one connecting structure comprises a through-hole plating which connects two individual loop structures of two windings or a common one of the at least two windings arranged in different planes, and
the two individual loop structures are configured to end at the through-hole plating before the corresponding end of the receiving structure.

4. The measured value acquisition device according to claim 3, wherein the through-hole plating is arranged in the region of an intersection point of the two individual loop structures arranged in different planes.

5. The measured value acquisition device according to claim 1, wherein the at least one connecting structure comprises a conductor path piece which is connected at contact points in each case to one end of two individual loop structures of two windings arranged in the same plane or of a common one of the at least two windings and connects them to one each other.

6. The measured value acquisition device according to claim 1, wherein the at least one connecting structure comprises a through-hole plating and at least one conductor path piece in one of the two planes or in both planes and connects two individual loop structures of two windings or a common one of the at least two windings arranged in different planes.

7. The measured value acquisition device according to claim 6, wherein the through-hole plating is connected in one plane to one end of one of the two loop structures and in the other plane to the at least one conductor path piece, which is connected at a contact point to one end of the other of the two loop structures.

8. The measured value acquisition device according to claim 6, wherein a first conductor path piece is connected in one plane to the through-hole plating and at a contact point to one end of one of the loop structures, and a second conductor path piece is connected in another plane to the through-hole plating and at a contact point to one end of the other of the two loop structures.

9. The measured value acquisition device according to claim 1, wherein:
the loop sections of the two loop structures each repeat periodically, and
a complete period of the loop sections corresponds to a sinusoidal curve or a rectangular curve or a triangular curve and a number of the periodically repeating loop sections defines a periodicity of the receiving structure.

10. The measured value acquisition device according to claim 9, wherein the sections of the individual loop structures arranged in different planes of the circuit carrier correspond to a half or a quarter or an eighth period of the repeating loop sections.

11. The measured value acquisition device according to claim 1, wherein the distance of adjacent loop structures of the at least one receiving structure is based on a number of receiving structures and on a number of receiving coils and on a number of windings of the at least one receiving coil and on the periodicity of the at least one receiving structure.

12. The measured value acquisition device according to claim 1, wherein the distances between the loop structures and the windings of the at least one receiving coil of the same receiving structure are the same.

13. The measured value acquisition device according to claim 1, wherein loop structures of the windings of a plurality of receiving coils are arranged alternately or grouped after the receiving coils along the receiving structure.

14. An inductive sensor arrangement for detecting a movement of a movable body having at least one coupling device and a measured value acquisition device which is designed according to claim 1, wherein:
the at least one coupling device or the measured value acquisition device is coupled to the movable body, whose movement is to be detected,
at least one exciter structure is arranged on a circuit carrier of the measured value acquisition device,
the at least one exciter structure is coupled to at least one evaluation and control circuit which, during operation, couples a periodic alternating signal into the at least one excitation structure,
the at least one coupling device is designed to influence an inductive coupling between the at least one excitation structure and at least one receiving structure of the measured value acquisition device, and
the at least one evaluation and control unit is designed to receive and evaluate signals induced in the at least one receiving structure and to determine a current position of the movable coupling device relative to the at least one receiving structure and/or a current position of the movable body.

15. The inductive sensor arrangement according to claim 14, wherein the movable body performs a rotational movement about a rotational axis or performs a linear movement.
